(19) United States
(12) Patent Application Publication
(10) Pub. No.: US 2020/0168978 A1
(43) Pub. Date: May 28, 2020

(54) MULTI-APPLICATION SCENARIO PORTABLE ANTENNA

(71) Applicant: Dongguan Baiao Electronics Technology Co., Ltd., Dongguan (CN)

(72) Inventors: Xiaobing Liu, Ji'an (CN); Qin Li, Ganzhou (CN)

(21) Appl. No.: 16/550,334

(22) Filed: Aug. 26, 2019

(30) Foreign Application Priority Data
Nov. 23, 2018 (CN) 201821939966.1

(51) Int. Cl. H01Q 1/08; H01Q 1/10; H01Q 1/12

(52) U.S. Cl. CPC H01Q 1/084; H01Q 1/12; H01Q 1/10

(57) ABSTRACT

The present application provides a multi-application scenario portable antenna, including an antenna body, a housing and a PCBA board, wherein the housing is provided with a receiving groove for storing the antenna body, a base of the antenna body is fixedly arranged in the receiving groove by a flip joint, and the wall of the receiving groove is provided with a notch, and the housing is detachably connected to a fixing seat of the antenna by the connecting member. The antenna body includes a first antenna body and a second antenna body, one end of the receiving groove is provided with a step, and a base of the first antenna body is arranged on the step by a first flip joint, and a base of the second antenna body is arranged on the bottom of the receiving groove at the other end thereof through a second flip joint.

### CROSS REFERENCE TO RELATED APPLICATIONS

The present application claims the benefit of Chinese Patent Application No. 201821939966.1 filed on Nov. 23, 2018, the contents of which are incorporated herein by reference in their entirety.

### TECHNICAL FIELD

The present application belongs to the technical field of communication, and particularly relates to a multi-application scenario portable antenna.

### TECHNICAL BACKGROUND

The TV antenna in the prior art has a large size, is not mobile enough after installation, and is generally only suitable for use in a fixed scenario, so the portability thereof is not good. In order to meet the requirements for portable mobile screens such as a laptop, a tablet, and a small-sized TV to watch a TV, the construction of the TV antenna in the prior art needs to be improved.

### SUMMARY

Based on the problems mentioned in the technical background, the present application provides a multi-application scenario portable antenna, which satisfies the requirements of portability and ease of installation of a TV antenna in a multi-application scenario, and the specific technical contents thereof are as follows:

A multi-application scenario portable antenna includes an antenna body, a housing, and a PCBA board built in the housing, wherein the housing is provided thereon with a receiving groove for storing the antenna body, the base of the antenna body is fixedly arranged in the receiving groove by a flip joint and is connected to the PCBA board so that the base is rotated around the flip joint to be received into the groove or extracted from the groove, and the wall of the receiving groove is provided with a notch to perform an extraction operation of the antenna body, the housing has a connecting member extending beyond the surface of the housing, the housing is detachably connected to a fixing seat of the antenna by the connecting member.

In one or more embodiments of the present application, the antenna body includes a first antenna body and a second antenna body, and one end of the receiving groove is provided with a step, a base of the first antenna body is arranged on the step by a first flip joint, and a base of the second antenna body is arranged on the bottom of the receiving groove at the other end thereof through a second flip joint, so that the first antenna body and the second antenna body are laid up and down during receiving.

In one or more embodiments of the present application, the antenna body is a retractable antenna.

In one or more embodiments of the present application, the connecting member includes a connecting rod and a connecting head at a free end of the connecting rod, the fixing seat of the antenna is a suction disk, the top end of the suction disk is provided with a first protrusion post, and the first protrusion post is provided with a cavity in which the connecting head is embedded, and the cavity has openings with different orientations which the connecting head is inserted into or withdrawn from.

In one or more embodiments of the present application, the connecting member includes a connecting rod and a connecting head at a free end of the connecting rod, the fixing seat of the antenna is a buckle, the a second protrusion is arranged at a top end of the buckle, and a catch groove for receiving the connecting head is arranged in the second protrusion post, an opening of the catch groove is a lateral opening, and the top of the catch groove has a catch position cooperating with the connecting rod, and the connecting member is extended into or withdrawn from the side.

In one or more embodiments of the present application, the buckle includes a horizontal base and two clamp arms extending downward from both sides of the horizontal base, and the extension lengths of the two clamp arms are different.

Compared with the prior art, the advantage of the present application is that two retractable antenna bodies combined with a PCBA board and a detachable antenna base constitute an overall antenna body, the antenna body is flipped from the receiving groove of the housing when in use and pulled out to form a specified angle, the fixing seat of the antenna includes a suction disk or a buckle, and two differently oriented openings connecting the cavities of the suction disk provided on the protrusion post of the suction disk facilitate the suction disk to have two installation directions, so that the antenna body is placed directly on a desk surface or attached to glass and a wall surface. If the buckle is mounted, the buckle can be clamped on a portable mobile screen such as a laptop, a tablet, a small-sized TV, etc. for use. When not in use, the suction disk or the buckle is removed, an antenna post can be folded up for easy carrying.

### BRIEF DESCRIPTION OF DRAWINGS

FIG. 1 is a schematic view of a combined structure of a housing in a receiving state according to Embodiment 1 of the present application.

FIG. 2 is a schematic view of a disassembled structure of a housing in a receiving state according to Embodiment 1 of the present application.

FIG. 3 is a schematic view of a disassembled structure of a housing in an unfolded state according to Embodiment 1 of the present application.

FIG. 4 is a schematic structural view of a suction disk according to Embodiment 1 of the present application.

FIG. 5 is a schematic view of a use state of an adsorption level according to Embodiment 1 of the present application.

FIG. 6 is a schematic view of a use state of an adsorption vertical surface according to Embodiment 1 of the present application.

FIG. 7 is a schematic view of an overall structure of Embodiment 2 of the present application.

FIG. 8 is a schematic view of a partial structure of Embodiment 2 of the present application.

### DETAILED DESCRIPTION

The solution of the present application is further described below with reference to the accompanying drawings:

### Embodiment 1

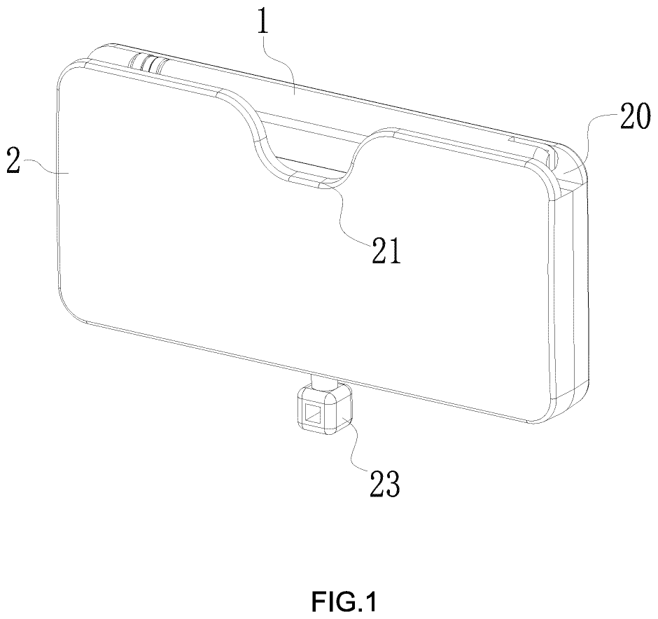

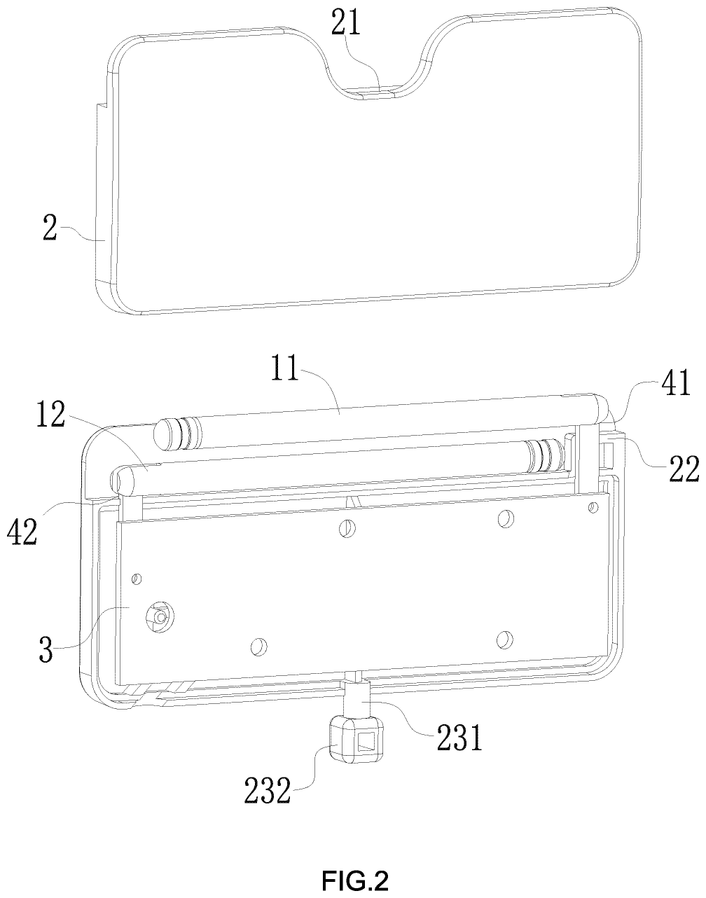

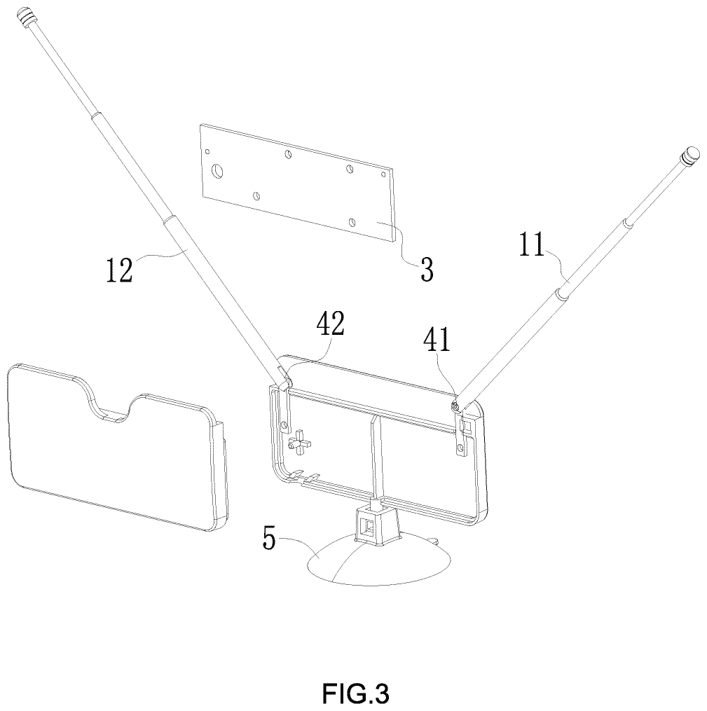

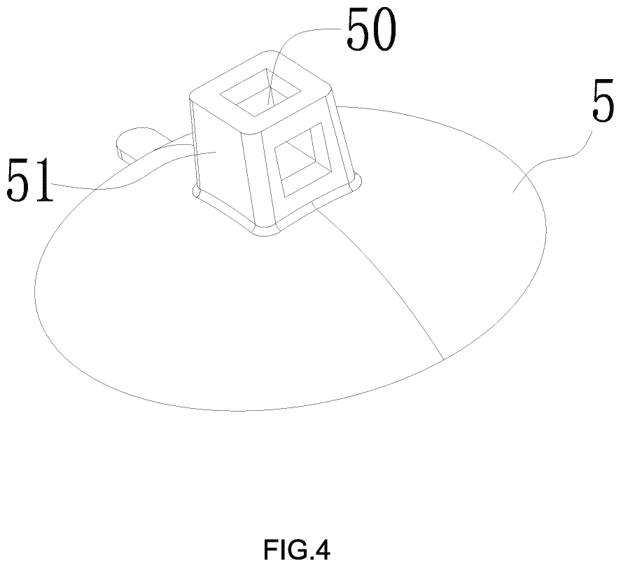

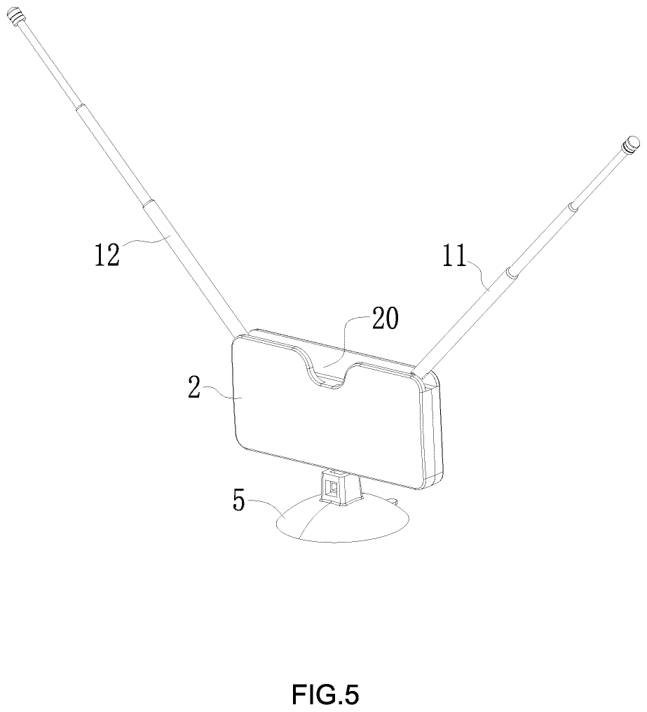

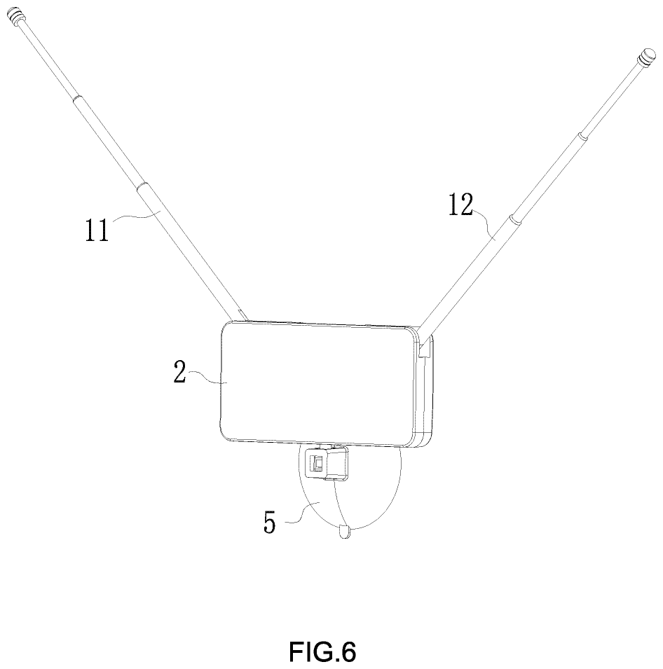

Referring to FIGS. 1 to 6, a multi-application scenario portable antenna includes an antenna body 1, a housing 2, and a PCBA board 3 built in the housing 2, wherein the housing 2 is provided thereon with a receiving groove 20 for storing the antenna body 1, the base of the antenna body 1 is fixedly arranged in the receiving groove 20 by a flip joint 4 and is connected to the PCBA board 3 so that the PCBA board is rotated around the flip joint 4 to be received into the groove or extracted from the groove, and the wall of the receiving groove 20 is provided with a notch 21 to perform an extraction operation of the antenna body 1, the antenna body 1 is a retractable antenna, and specifically includes a first antenna body 11 and a second antenna body 12, one end of the receiving groove 20 is provided with a step 22, a base of the first antenna body 11 is arranged on the step 22 by a first flip joint 41, a base of the second antenna body 12 is arranged on the bottom of the receiving groove at the other end thereof through a second flip joint 42, so that the first antenna body 11 and the second antenna body 12 are laid up and down during receiving, the design not only considers the receiving problem of the antenna main body 1, but also minimizes the thickness of the housing 2, which is convenient for the user to carry; the housing 2 has a connecting member 23 extending from the surface of the housing, and the housing 2 is detachably connected to the fixing seat of the antenna by the surface of the housing, the connecting member 23 includes a connecting rod 231 and a connecting head 232 at a free end of the connecting rod 231, the fixing seat of the antenna is a suction disk 5, the top end of the suction disk 5 is provided with a first protrusion post 51, the first protrusion post 51 is provided with a cavity 50 in which the connecting head 232 is embedded, and the cavity 50 has openings with different orientations which the connecting head 232 is inserted into or withdrawn from.

### Embodiment 2

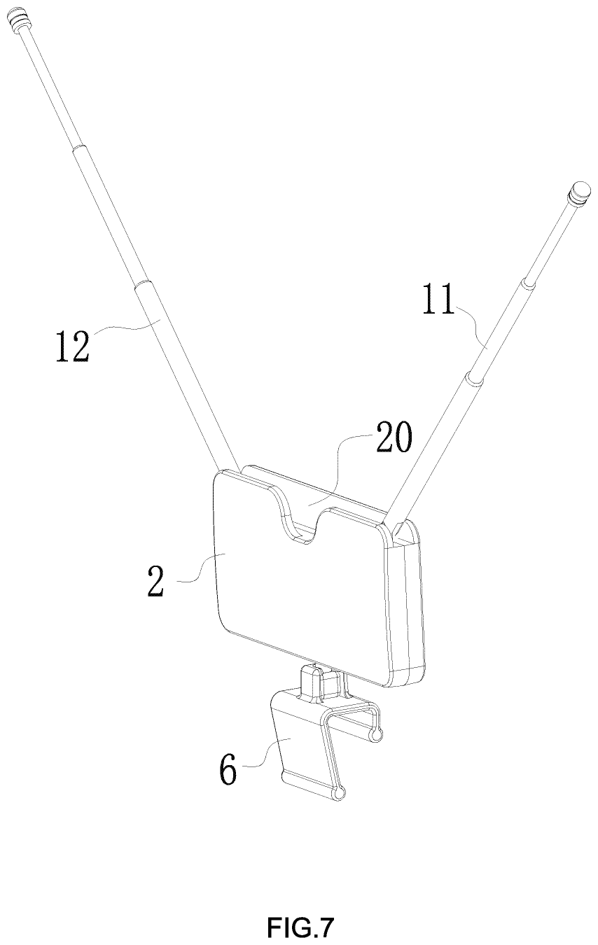

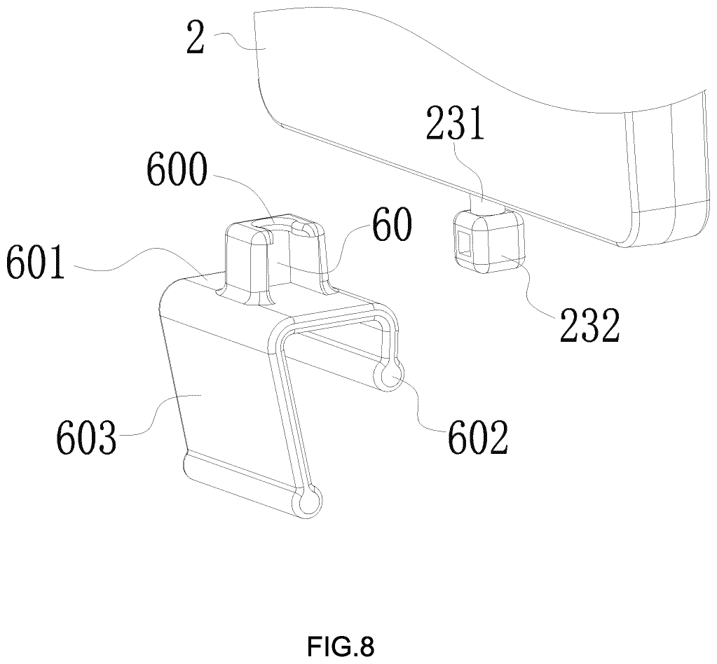

Referring to FIGS. 7 to 8, the differences of Embodiment 2 from embodiment 1 are that the fixing seat of the antenna is a buckle 6, the top end of the buckle 6 is provided with a second protrusion post 61, and the second protrusion post 61 is a catch groove 60 in which the connecting member 232 is received, an opening of the catch groove 60 is a lateral opening, the top of the catch groove 60 has a catch position 600 cooperating with the connecting rod 231, the connecting rod 23 extends into or is pulled out of the side thereof. Further, the buckle 6 includes a horizontal base 601 and a front clamp arm 602 and a rear clamp arm 603 both extending downward from both sides of the horizontal base 601, the rear clamp arm 603 has a larger extension length than that of the front clamp arm 601 so as to be clamped and placed on a display of a laptop or the like without obscuring the display of an interface.

The above-mentioned preferred embodiments are to be considered as illustrative of the embodiments of the solution of the present application, and any technical derivation, replacement, improvement, etc., which are based on the same, approximate or based on the solution of the present application, should be regarded as the protection scope of the present patent.

What is claimed is:

1. A multi-application scenario portable antenna, comprising an antenna body, a housing, and a PCBA board built in the housing, wherein the housing is provided thereon with a receiving groove for storing the antenna body, the base of the antenna body is fixedly arranged in the receiving groove by a flip joint and is connected to the PCBA board so that the base is rotated around the flip joint to be received into the groove or extracted from the groove, and the wall of the receiving groove is provided with a notch to perform an extraction operation of the antenna body, the housing has a connecting member extending beyond the surface of the housing, the housing is detachably connected to a fixing seat of the antenna by the connecting member.

2. The multi-application scenario portable antenna according to claim 1, wherein the antenna body comprises a first antenna body and a second antenna body, and one end of the receiving groove is provided with a step, a base of the first antenna body is arranged on the step by a first flip joint, and a base of the second antenna body is arranged on the bottom of the receiving groove at the other end thereof through a second flip joint, so that the first antenna body and the second antenna body are laid up and down during receiving.

3. The multi-application scenario portable antenna according to claim 1, wherein the antenna body is a retractable antenna.

4. The multi-application scenario portable antenna according to claim 2, wherein the antenna body is a retractable antenna.

5. The multi-application scenario portable antenna according to claim 1, wherein the connecting member comprises a connecting rod and a connecting head at a free end of the connecting rod, the fixing seat of the antenna is a suction disk, the top end of the suction disk is provided with a first protrusion post, and the first protrusion post is provided with a cavity in which the connecting head is embedded, and the cavity has openings with different orientations which the connecting head is inserted into or withdrawn from.

6. The multi-application scenario portable antenna according to claim 2, wherein the connecting member comprises a connecting rod and a connecting head at a free end of the connecting rod, the fixing seat of the antenna is a suction disk, the top end of the suction disk is provided with a first protrusion post, and the first protrusion post is provided with a cavity in which the connecting head is embedded, and the cavity has openings with different orientations which the connecting head is inserted into or withdrawn from.

7. The multi-application scenario portable antenna according to claim 1, wherein the connecting member comprises a connecting rod and a connecting head at a free end of the connecting rod, the fixing seat of the antenna is a buckle, the a second protrusion is arranged at a top end of the buckle, and a catch groove for receiving the connecting head is arranged in the second protrusion post, an opening of the catch groove is a lateral opening, and the top of the catch groove has a catch position cooperating with the connecting rod, and the connecting member is extended into or withdrawn from the side.

8. The multi-application scenario portable antenna according to claim 2, wherein the connecting member comprises a connecting rod and a connecting head at a free end of the connecting rod, the fixing seat of the antenna is a buckle, the a second protrusion is arranged at a top end of the buckle, and a catch groove for receiving the connecting head is arranged in the second protrusion post, an opening of the catch groove is a lateral opening, and the top of the catch groove has a catch position cooperating with the connecting rod, and the connecting member is extended into or withdrawn from the side.

9. The multi-application scenario portable antenna according to claim 7, wherein the buckle comprises a horizontal base and two clamp arms extending downward from both sides of the horizontal base, and the extension lengths of the two clamp arms are different.

10. The multi-application scenario portable antenna according to claim 8, wherein the buckle comprises a horizontal base and two clamp arms extending downward from both sides of the horizontal base, and the extension lengths of the two clamp arms are different.
